(19) United States
(12) Patent Application Publication
(10) Pub. No.: US 2004/0227759 A1
(43) Pub. Date: Nov. 18, 2004

(54) Plotting numerical data

(75) Inventors: David K. McKnight, Newmarket (CA); Jeffrey C. Turnham, Markham (CA)

Correspondence Address: International Business Machines, Intellectual Property Law, 11400 Burnet Road, Austin, TX, 78758, US

(73) Assignee: INTERNATIONAL BUSINESS MACHINES CORPORATION, ARMONK, NY (US)

(21) Appl. No.: 10/734,761

(22) Filed: Dec. 10, 2003

(30) Foreign Application Priority Data
May 15, 2003 (CA) 2428853

(51) Int. Cl. G06T 11/20

(52) U.S. Cl. 345/440

(57) ABSTRACT

Plotting numerical data is provided. A root object is selected and a user is presented with at least one filter for selection, where each filter describes at least one of a type of objects and a type of relationships between objects, each type of objects and each type of relationships between objects being defined by a schema. A set of objects is selected based on user-selected filters. Each object of the set is related to the root object either directly, or through a chain of intermediate objects, where each chain of intermediate objects has the same length and all objects at a given level of each chain have a relationship with a parent object which is identical. Each object of the set also contains numerical data having a format suitable for a mathematical analysis. The mathematical analysis of the numerical data is arranged and a result of which is plotted in a graph. Advantageously, the user is provided with some guidance for selecting the set of objects and all objects so selected contain numerical data suitable for plotting the desired graph.

This invention relates to plotting numerical data.

The significance of, and relationships between, a set of numerical data can be better grasped or understood by plotting the data or a result of a mathematical analysis of the data on one or more graphs. For example, line graphs, pie charts and bar graphs are often used to compare data and to show trends in data.

Many computer tools have been developed to automate the plotting process. There are two general approaches. In the first approach, a user explicitly selects each and every data object for plotting. For example, in a spreadsheet application, a user may select a number of cells (or columns and rows) in a spreadsheet for plotting; in a database application, a user may submit the result of a query for plotting. However, this approach has some drawbacks. A user may not know what to select or how to select the desired data. A user may also select data that is not all suitable for a particular analysis or plotting. For instance, non-numerical data may be included, or incomparable data (due to difference in either data format or data type) may be selected for a comparison chart.

In the second approach, data is automatically selected and plotted through a pre-programmed process. Although easy to use as a user can view a graph of data with minimal effort, the computing tools developed under this approach are generally not flexible. Different types of data and different types of graphs may require different tools. It is difficult to adapt a tool developed for one purpose to be used for another purpose. Further, a user usually has little control of the input data at run time. For example, many system usage analysis tools can plot a result of the analysis of system usage in a graphical format but the user usually cannot change the type of components included in the analysis or the type of graph that is displayed.

Accordingly, there is need for an improved method and computer tool for plotting numerical data.

### SUMMARY OF THE INVENTION

To allow plotting of numerical data, a user is presented with one or more filters for selection, where each filter describes at least one of a type of objects and a type of relationships between objects. The data to be plotted is selected based on one or more user-selected filters so as to ensure that the selected data has a certain chain of relationships with a root object and is of a suitable numerical format for a desired mathematical analysis and plotting.

According to one aspect of the present invention, there is provided a method of plotting numerical data, comprising selecting a root object; presenting to a user for selection at least one filter, each of which describes at least one of a type of objects and a type of relationships between objects, each type of objects and each type of relationships between objects being defined by a schema; receiving one or more user-selected filters; based on the user-selected filters, selecting a set of objects, each object of the set being related to the root object either directly, or through a chain of intermediate objects, where each chain of intermediate objects has the same length and all objects at a given level of each chain have a relationship with a parent object which is identical, each object of the set containing numerical data having a format suitable for a mathematical analysis; arranging the mathematical analysis of the numerical data; and plotting a result of the mathematical analysis of the numerical data on a graph.

According to another aspect of the invention, there is provided a computer system having a processor and a memory adapted for undertaking the method described in the above paragraph.

According to yet another aspect of the invention, there is provided a manufacture comprising a computer readable medium containing computer executable code for plotting numerical data which when executed by a processor in a computer system, causes the computer system to: select a root object; present to a user for selection at least one filter, each of which describes at least one of a type of objects and a type of relationships between objects, each type of objects and each type of relationships between objects being defined by a schema; receive one or more user-selected filters; based on the user-selected filters, select a set of objects, each object of the set being related to the root object either directly, or through a chain of intermediate objects, where each chain of intermediate objects has the same length and all objects at a given level of each chain have a relationship with a parent object which is identical, each object of the set containing numerical data having a format suitable for a mathematical analysis; arrange the mathematical analysis of the numerical data; and plot a result of the mathematical analysis of the numerical data on a graph.

According to still another aspect of the invention, there is provided a software tool for plotting numerical data, operable to select a root object; present to a user for selection at least one filter, each of which describes at least one of a type of objects and a type of relationships between objects, each type of objects and each type of relationships between objects being defined by a schema; receive one or more user-selected filters; based on the user-selected filters, select a set of objects, each object of the set being related to the root object either directly, or through a chain of intermediate objects, where each chain of intermediate objects has the same length and all objects at a given level of each chain have a relationship with a parent object which is identical, each object of the set containing numerical data having a format suitable for a mathematical analysis; arrange the mathematical analysis of the numerical data; and plot a result of the mathematical analysis of the numerical data on a graph.

Other aspects and features of the present invention will become apparent to those of ordinary skill in the art upon review of the following description of specific embodiments of the invention in conjunction with the accompanying figures.

### BRIEF DESCRIPTION OF THE DRAWINGS

In the figures, which illustrate example embodiments of the invention,

FIG. 1 schematically illustrates a hierarchy of data objects,

FIG. 2 is a block diagram illustrating an exemplary schema for describing data objects,

FIG. 3 is a block diagram illustrating an exemplary set of data objects described by the schema of FIG. 2,

FIG. 4 is a flow chart illustrating the steps of an exemplary method embodying the present invention,

FIG. 5 is a schematic diagram illustrating a computer system adapted for undertaking the method of FIG. 4,

FIG. 6 is a flow chart illustrating the logic of an exemplary software tool for executing the method of FIG. 4,

FIGS. 7 is a block diagram illustrating exemplary data filters and the objects selected after applying the filters to the data objects of FIG. 3, and

FIG. 8A-8B are exemplary graphs plotted according to the method of FIG. 4.

### DETAILED DESCRIPTION

As used herein, the following terms have the following meanings.

“Plot”, as a verb, means displaying one or more graphical objects wherein each graphical object represents a numerical value with a visible characteristic of the graphical object correlated to the magnitude of the numerical value. Visible characteristics include size, color, shade, and relative location (such as coordinates) of the graphical object. Plotting does not include displaying a numerical value itself in a textual form.

“Graph”, as a noun, means a graphical representation of numerical data wherein some numerical data is plotted, and includes diagrams, charts, and the like. Examples of graphs include histograms, pie charts, bar graphs, line graphs, scatter graphs, area graphs, contour (or surface) graphs, and the like. Text such as titles, legends and labels may be displayed in a graph.

In overview, a subset of numerical data from a data set is selected, analyzed, and plotted, wherein a user is allowed to choose the constraints imposed on what is selected and plotted. To select the data, the user is presented with one or more filters for selection and the numerical data to be plotted is selected based on the user-selected filters. A filter describes the type of objects or the type of relationships between objects that can be selected. It is an object selection constraint that can be used to select data objects by limiting the type of objects or the type of relationships between objects that the selected data objects can have. The filters presented to the user are determined based on a schema that describes the relevant data objects to ensure that the selected data objects are all of a certain type, have a certain chain of relationships with a root object, and the data contained in the selected data objects are of a suitable numerical format for a desired mathematical analysis and plotting. Since the filters can be generically defined, as will become apparent below, a generic plotting tool can be developed for various purposes.

In order to demonstrate the embodiments of the present invention, data objects are described herein with a particular data model. It should be understood that other suitable models may be used.

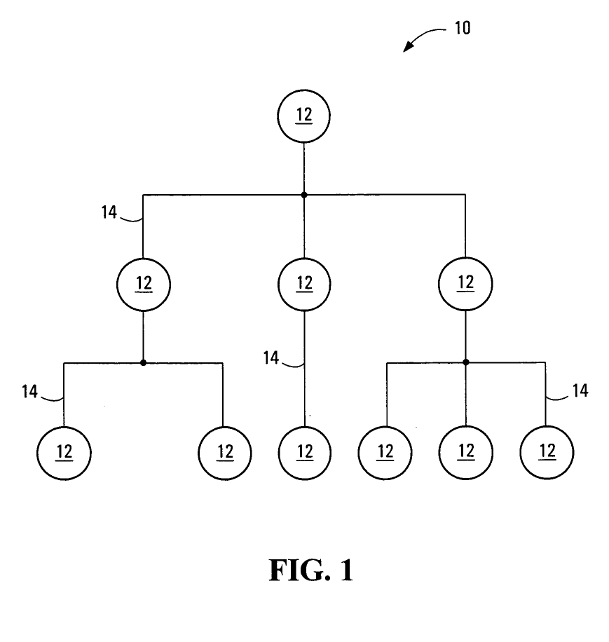

Referencing FIG. 1, interrelated data objects 12 (represented by circles) generally have a hierarchical structure 10 wherein between each pair of related objects 12 a relationship 14 (represented by a line) exists.

Objects 12 and relationships 14 may be of different types. For example, objects 12 related to computer systems include systems, processes that are run in a system, memories that are used by processes, commands that are executed by processes, and central processing unit (CPU) times used by processes. The relationships 14 between these objects 12 include content relationships (e.g., processes are contents of a system) and attribute relationships (e.g., memory used by a process is an attribute of the process).

These different types and the hierarchical structure 10 of a given set of objects 12 can be described by using a schema created for describing that particular set of objects. A schema defines object types, relationship types, and the relationships 14 that any two given types of objects 12 can have.

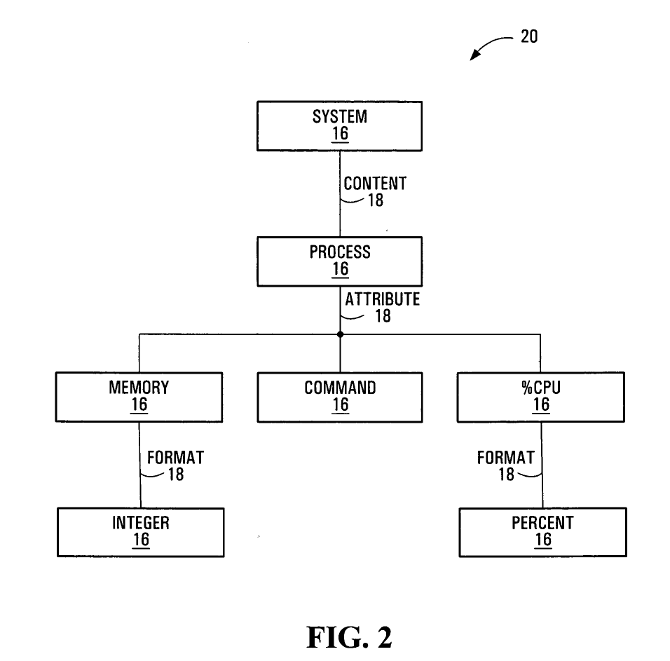

An exemplary schema 20 is illustrated in FIG. 2 for describing objects related to computer systems. In schema 20, the type of an object 12 is described by an object descriptor 16 (represented by a rectangular box). The type of a relationship 14 is described by a relationship descriptor 18 (represented by a line linking two boxes). It may be appreciated that the descriptors, both object descriptors 16 and relationship descriptors 18, are themselves objects, descriptor objects. They can be respectively related to an “OBJECTDESCRIPTOR” object and a “RELATIONDESCRIPTOR” object in a “DESCRIPTOR” relationship. However, to make FIG. 2 simpler, these latter two objects and their relationships to descriptor objects 16 and 18 are not shown.

Schema 20 also associates specific relationship descriptors 18 between specific object descriptors 16. Such association defines what specific relationships each pair of objects are permitted to have. As defined in schema 20, A SYSTEM object may have a PROCESS object as its content. Therefore, a PROCESS object has a content relationship with a SYSTEM object and can have attribute relationships with a MEMORY object, a COMMAND object, and a %CPU object. A MEMORY object is an attribute of a PROCESS object and has an INTEGER FORMAT. Similarly, a %CPU object is an attribute of a PROCESS object and has a PERCENT FORMAT.

The schema 20 also includes object descriptors “INTEGER” and “PERCENT” for describing format of numerical data, and a “FORMAT” relationship descriptor for describing the relationship between an object containing numerical data and its format object descriptor. As defined in schema 20, a MEMORY object can only have an INTEGER format and a %CPU object can only have a PERCENT format. The benefit of defining format object descriptors and a format relationship descriptor will become clear from descriptions below.

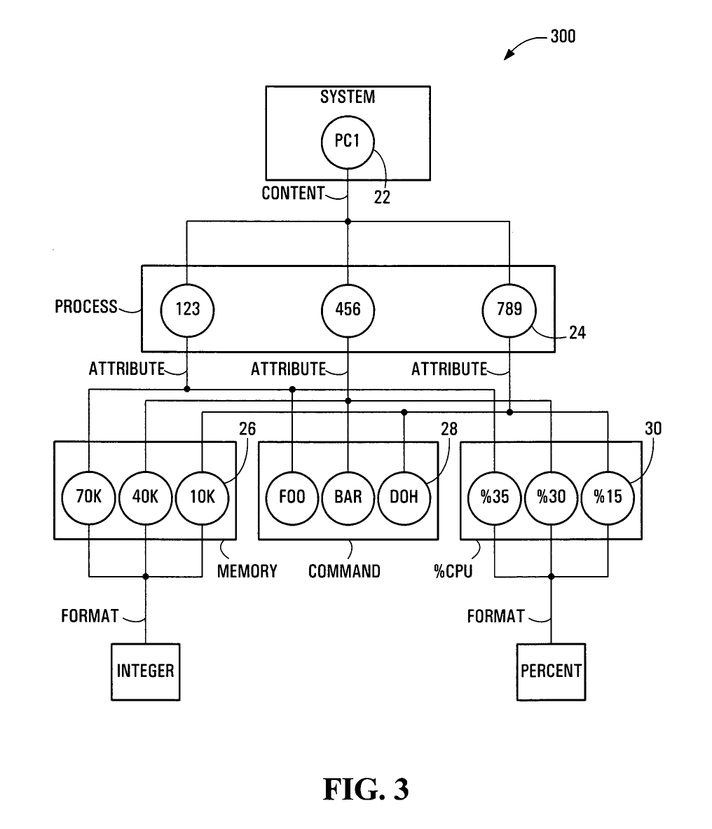

Of course, other formats of numerical data are possible and one type of objects 12 may have a plurality of different formats. For example, with reference to FIG. 3, it is possible for SYSTEM objects 22 and PROCESS objects 24 to have a format “STRING” and MEMORY objects 26 to have a generic format “NUMBER”. Other relationships are also possible. For example, a content relationship may exist between a MEMORY object and a SYSTEM object. Such other possible variations are precluded in schema 20 for ease of description and illustration.

When a schema is determined, it can be populated with data objects 12. In other words, data objects 12 can be related to the object descriptors and with each other using the appropriate relationship descriptors 18 as defined by the schema.

FIG. 3 illustrates an exemplary set of data objects 300 (circles) populating and described by schema 20. To keep FIG. 3 simple, the DESCRIPTOR relationship between a data object 12 and a descriptor object 16 is indicated by enclosing the data object 12 in the descriptor object 16 box, rather than by a line link. That is, an object enclosed within a descriptor object is described by the descriptor object enclosing it.

Therefore, a computer system named “PC1” 22 is a SYSTEM object. “PC1” 22 has three CONTENTs, PROCESS objects 24 “123”, “456”, and “789”. Each PROCESS object 24 has three ATTRIBUTEs: PROCESS “123” has “70K” of MEMORY, a COMMAND called “FOO”, and used “%35” %CPU; PROCESS “456” has “40K” of MEMORY, a COMMAND called “BAR”, and used “%30” %CPU;PROCESS “789” has “10K” of MEMORY, a COMMAND called “DOH”, and used “%15” of CPU. The MEMORY objects 26 “70K”, “40K”, and “10K” all have an INTEGER format, the COMMAND objects 28 are not numerical data (thus their format need not be defined for the purposes of this description), and the %CPU objects 30 “%35”, “%30” and “%15” all have a PERCENT format.

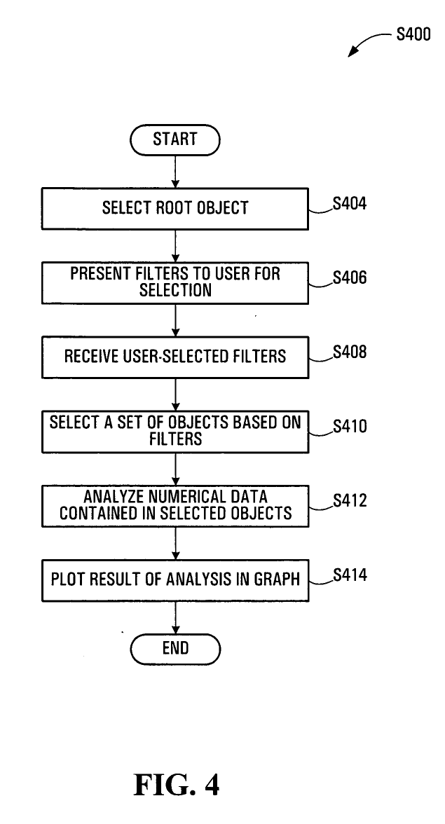

With a schema such as schema 20 populated with data objects 12 such as data set 300, numerical data contained in the data objects 12 may be selected and plotted following the exemplary steps S400 illustrated in FIG. 4. The schema may be determined and populated in various manners. The schema may be pre-existing and thus only need to be retrieved. A retrieved schema may be already populated or population may be undertaken as a preliminary step to steps S400. Alternatively, the schema may also be constructed and populated in preliminary steps to steps S400.

In steps S400, a root object is selected (S404). The root object may be an object anywhere in the data hierarchy. For example, a root object may be an object 24 or an object 26 in FIG. 3. The root object may be a pre-selected object or a user selected object.

Once a root object is selected, the relationships that the root object can have, and all the objects that relate to the root object, can be automatically ascertained by referencing to the schema used to describe the objects. An object may relate to the root object either directly, or indirectly through a chain of related objects. Available filters for selecting objects (e.g., a filter to determine all objects contained by the root object) can thus be ascertained and selectively presented to the user at S406. Of course, if there is no filter available, the plotting can be terminated or another root object can be selected.

One or more user selected filters are received at S408, and used to select a set of objects wherein each object of the selected set has the same length of chain of object linking it to the root object, has the same relationship with a parent object at each given level of the chain, and contains numerical data having a format suitable for a mathematical analysis (S410).

As can be appreciated, two objects may be related directly or indirectly. A chain refers to the chain of relationships and the intermediate objects, if there is any, between two objects. The length of a chain refers to the number of intermediate objects. For example, the chain between two directly related objects has a zero length and the chains between object 22 and objects 26 all have a length of one. A parent object of a second object is the intermediate object directly related to the second object but closer in relationship to the root object. For example, if object 22 is the root object, an object 24 may be the parent object of an object 28.

The mathematical analysis to be performed on selected data can be predefined or can be selected based on user input during or before S410. Further, if selected by a user, the selection of mathematical analysis can be explicit or implicit. For example, a user may be presented a choice of different graphs to plot, once the user selects a particular graph, the mathematical analysis required may be determined. Or, when a certain type of objects is selected (such as “percent”), the mathematical analysis may also be accordingly determined (such as pie chart comparison).

When multiple filters need to be selected, they can be presented and selected in one execution of S406 and S408, or in multiple executions, i.e., it is possible to return from S408 to S406 to make additional selections. Further, instead of selecting objects after all user-selected filters have been received, some selection of the objects may be performed as each filter is determined, i.e., returning from S410 to S406 or S408.

At S412, the mathematical analysis is undertaken or arranged to be undertaken. A mathematical analysis may include any mathematical manipulation or transformation of the numerical data such as a statistical analysis. In appropriate cases, the numerical data may simply be passed to plotting without any changes to the values themselves. For instance, two sets of numbers may simply be plotted in a scatter graph wherein the two coordinates of each data point on the graph are respectively proportional to two numerical values contained in the selected objects. The mathematical analysis may be carried out with any number of mathematical analysis tools, which can be separate from, or incorporated within, the tool for selecting the objects.

The result of the mathematical analysis is then plotted on one or more graphs in S414. Again, the plotting tool may be incorporated within the tool for selecting the objects, incorporated with the mathematical analysis tool, or a separate tool by itself. Plotting can be carried out in any manner known to a skilled person in the art.

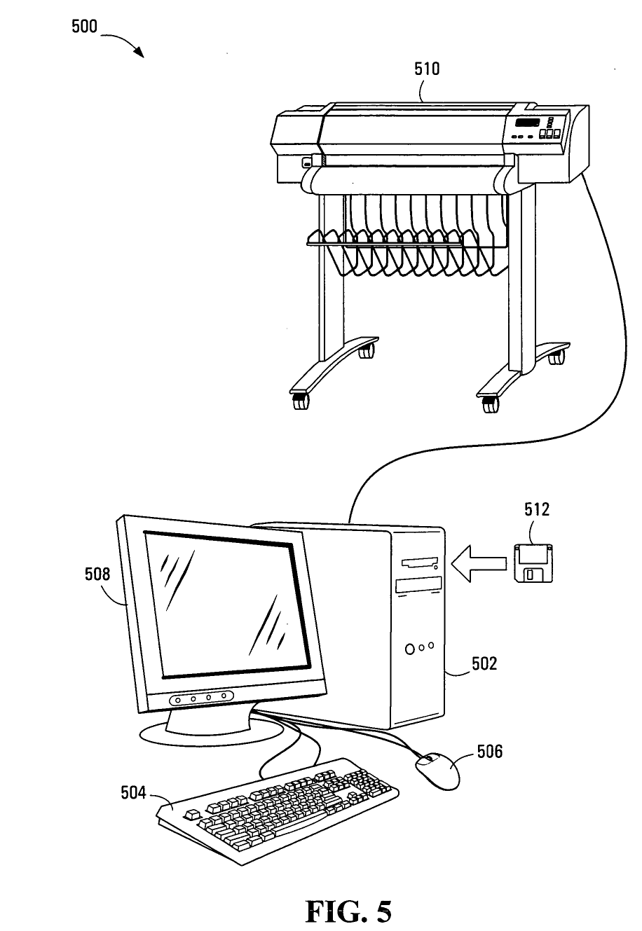

Referencing FIG. 5, a computer system 500 can be adapted to undertake S400. The computer system 500 has a central processing unit 502, which includes a processor and a memory. One or more Input peripherals, such as a keyboard 504 and a mouse 506, and one or more output devices, such as a display monitor 508 and a plotter 510, are connected to the central processing unit 502. The computer system 500 may include hardware to network with other computers (not shown).

The computer system 500 has access to data objects 12 to be selected for plotting, which can be stored in the memory or any other electronic storage accessible by central processing unit 502. The computer system 500 can be loaded with one or more software tools for executing methods exemplary of this invention from an electronic storage, such as storage 512, which can be the same or a different storage from the one storing objects 12. An electronic storage, such as storage 512, is a computer readable medium, such as a disk, a tape, a chip or a random access memory, and can be local or remote, permanent or temporary, removable or non-removable. The software tools may be stored in the form of computer executable code.

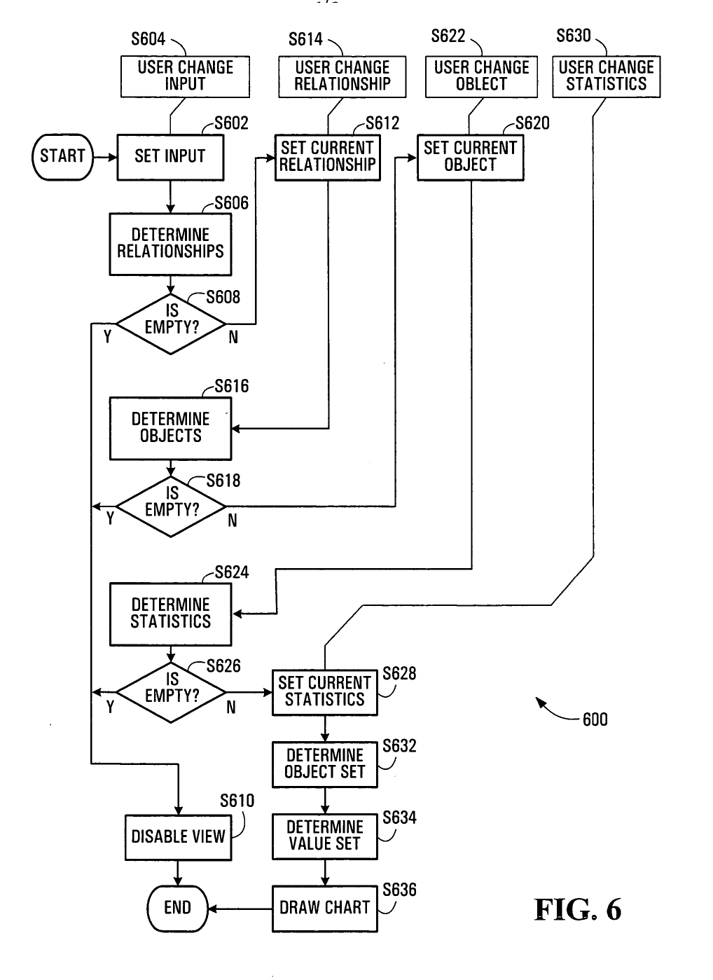

FIG. 6 shows the logic S600 of an exemplary software tool implementing S400 for plotting statistical analysis of numerical data.

An input menu is displayed for selecting the root object (S602), from which the user may select an object as the root object (S604). To help the user to make the selection, a list of candidate objects may be provided. Alternatively, a window containing a graphical representation of the objects may be displayed.

After the root object is selected, the relationship(s) the root object may have can be determined (S606). If the root object has no relationship with other data objects (S608), the plotting procedure is terminated (S610). If there are one or more relationships available (S608), these relationships are displayed in a relationship menu (S612) so that the user can chose one from them (S614) for filtering the objects. The relationships may be displayed using, for example, the corresponding relationship descriptors, such as “content”, “attribute”, or the like.

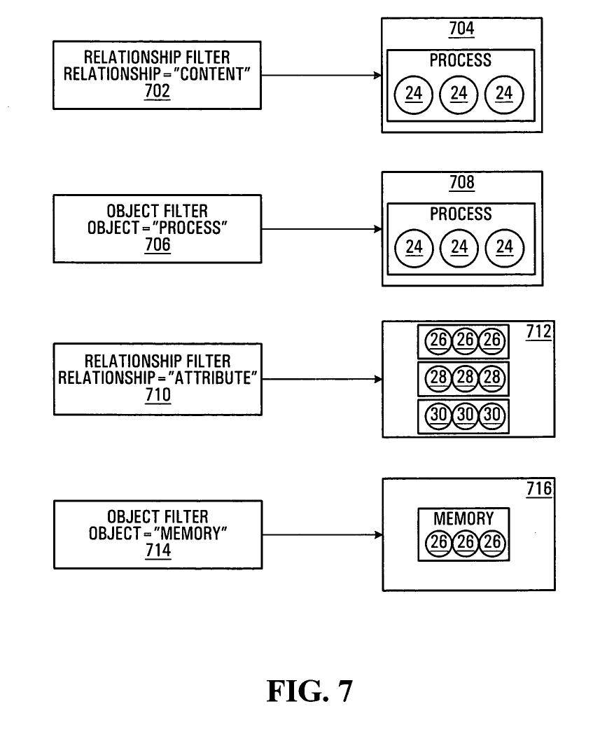

When the user selects a particular relationship, that particular relationship becomes the Current Relationship and a corresponding relationship filter can be determined (S612). A filter may be expressed as, e.g., “relationship=<current relationship>”. Objects related to the root object are filtered with this relationship filter to select objects that are related to the root object in the Current Relationship (S616). If there is no object having the Current Relationship with the root object (S618), the plotting is terminated (S610). If there are one or more objects having the Current Relationship with the root object (S618), an object menu is displayed showing the object descriptors of these objects (S620), from which the user may select a Current Object (S622). For example, if the root object has three types of contents, i.e., the root object is related in a content relationship with objects which in turn are respectively related to three descriptor objects, then three items may be displayed in the object menu, each being one of the three object descriptors. The user may select one of the three displayed object descriptors as the Current Object. This is similar to the example illustrated hereafter in FIG. 7.

Based on the user selection at S622, statistical analyses available to the type of objects described by the Current Object can be determined (S624). Possible statistical analyses may be predefined or limited, or they can depend on an analysis tool the data selecting tool may invoke. Possible graphs that can be plotted may also be determined at this time. In the exemplary implementation illustrated in FIG. 6, the numerical data may be simply plotted without further transformation, thus the user only need to select what and how to plot. If there is no available analysis (S626), such as when the user has selected a textual type of objects, the plotting is terminated S610.

If there are one or more statistical analyses and plotting options available (S626), the user is presented with an analysis menu displaying the available options (S628). For example, if there are only two possible options, “memory usage analysis plotted as a bar graph” and “CPU usage analysis plotted in a pie chart”, these two options would be displayed. Of course, the analysis menu may simply display “memory usage” and “CPU usage”. If more than one type of graphs can be plotted for a given analysis, the options may also be presented, e.g., in a submenu stemming from the corresponding analysis item. The user can select the type of analysis and graph it would like to see (S630).

At this stage, the type of mathematical analysis to be performed and the type of graph to be plotted have been selected but it remains to choose data to populate the graph. Once the above user selections are made and received, all of the filters for selecting the set of data objects for plotting can be determined. The filters include a relationship filter for selecting all data objects that are related to the root object with the Current Relationship, an object filter for selecting all data objects related to the root object in the Current Relationship, and one or more further filters for selecting data objects related to the Current Object in a relationship dictated by the statistics menu selection, as illustrated by examples below and in FIG. 7. Based on the determined filters, a set of objects (the Object Set) is selected (S632). The numerical values contained in the objects in the Object Set can thus be determined (S634), analyzed and plotted (S636).

The logic of S600 is further illustrated with examples and references to FIG. 7. The examples also make use of the exemplary schema 20 of FIG. 2 and object set 300 of FIG. 3.

In one example, SYSTEM object “PC1” 22 is selected as the root object (S602 and S604). The only possible relationship “PC1” 22 may have is a CONTENT relationship 24 (S606). The menu thus shows only one item: “content” (S612), which the user selects (S614). CONTENT is thus set as the Current Relationship. A corresponding relationship filter 702, expressed for example as “relationship=“content””, is applied to all the objects that are related to “PC1” to select the objects that are related to “PC1” in a CONTENT relationship (S616). The “PROCESS” objects 24, “123”, “456”, “789” are selected as the selected set 704.

The objects in the selected set 704 are all related to only one object descriptor, the PROCESS object descriptor, which is displayed in the object menu (S620) and selected by the user as the Current Object (S622). An object filter 706, “object=“process””, is applied to the selected set 704 to select the objects that are PROCESS objects. Obviously, the PROCESS objects 24, “123”, “456”, “789” are again selected as the selected set 708.

There are two possible statistical analyses available for PROCESS objects: comparisons of memory usage and CPU usage, where memory usage can only be plotted in a bar graph and CPU usage can only be plotted in a pie chart (S624). Thus the statistics menu displays two options: “memory usage” and “CPU usage” (S628).

Assuming the user selects the “memory usage” option (S630). This means that the ultimately selected objects should be (i) memory objects (ii) that are related to one of the objects in selected set 708 in an attribute relationship and (iii) contain numerical data that is of a format suitable for being plotted in a bar graph.

Thus, to meet criterion (ii), a further relationship filter 710, relationship=“attribute”, is applied to the selected set 708 to select the objects that are related to one of the PROCESS object 24 in an ATTRIBUTE relationship. Nine objects, objects 26, 28, and 30, are selected as the selected set 712.

To meet criterion (i), a further object filter 714, object=“memory”, is applied to the selected set 712 to select the objects that are MEMORY objects. Only objects 26 are selected as the selected set 716.

The only allowed numerical formats in schema 20 are INTEGER and PERCENT. The criterion (iii) is automatically satisfied here because the MEMORY descriptor is only related to the INTEGER format, which is a suitable format for plotting bar graphs. Under good programming practice, objects containing data of different formats should have different object types, i.e., be associated with different object descriptors. Therefore, in many cases, as in this case, a format filter is not necessary because the selected objects all have the same format. In cases where the selected set may contain more than one type of objects, a format filter may need to be applied to the selected set to avoid mismatch or meaningless comparisons. For example, if the selected memory objects could have one of two formats, an INTEGER format or a PERCENT format, a format filter might be required to avoid comparing integers to percentages.

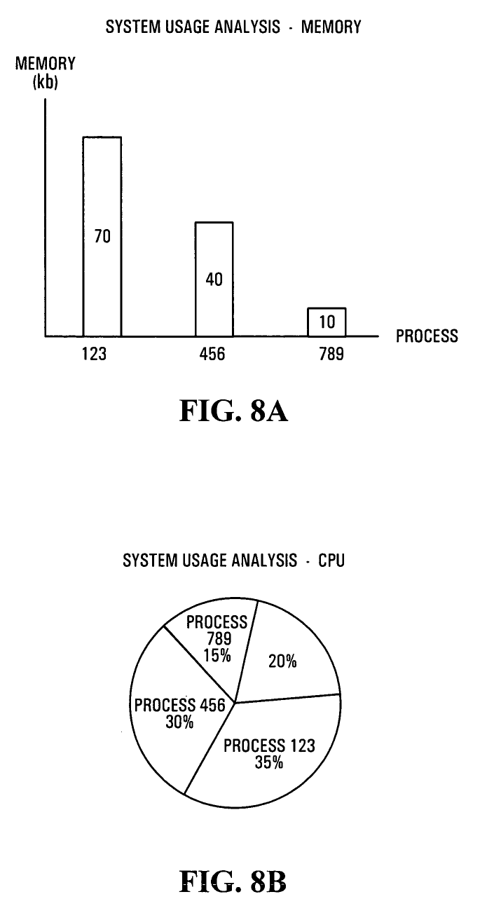

Ultimately, MEMORY objects 26 are selected for plotting. A bar graph of the memory usage values contained in objects 26 is plotted as shown in FIG. 8A.

In another example, the user may similarly choose the plot “CPU usage” at step S628. In this case, the object filter 714 is changed to “object=“%cpu””, and accordingly, the allowed format is changed to PERCENT and the graph type to pie chart. The final selected set contains objects 30. The resulting plot is shown in FIG. 8B.

Conveniently, during the selection process, the user is provided with limited options which include indications of what each choice is and how it is related to a parent object. Thus, the user is provided with useful information and guidance for making meaningful selections. As predefined constraints are implemented in the filters and filters that are not presented to user for selection cannot be selected, the user can be prevented from making inappropriate selections, such as due to typing errors or mismatching of data type or format.

Further, as alluded to earlier, the logic S600 is generic and is not dependent on a particular schema or a particular set of data objects. It can work with other schema or other sets of data objects, as long as the schema is compliant with a suitable data model. As can be appreciated from the above exemplary embodiments and examples, while schema or data set specific information is presented during the selection process, it can be obtained dynamically after the user has made a selection. Thus, the logic S600 or a software tool implementing the logic can be a general purpose plotting tool and a software code implementing logic S600 for one purpose may be easily reused for other purposes.

As can be appreciated, once the user inputs have been received and data filters determined, the selection of the final object set or the determination of the data values contained in the selected objects may be performed at any later time, or repeatedly over time with updated data. For instance, a memory or cpu usage graph may be updated periodically without any further input from the user. An update may also be triggered by the occurrence of a certain event instead of passage of time. An updated graph not only may reflect the changes in memory usage of an earlier selected process but may also show that a new process is now in progress and has a certain amount of memory usage.

Other features, benefits and advantages of the present invention not expressly mentioned above can be understood from this description and the drawings by those skilled in the art.

Of course, as can be appreciated, many modifications to the above described embodiments of the invention are possible.

For example, instead of terminating the plotting procedure at S610, the user may be optionally presented again with the last displayed menu so that the user may have an opportunity to decide if he or she wants to abort or try another selection.

Where a menu is displayed, a default entry may be provided. The user may accept the default or select another entry, if there is any. Further, an abort option may also be provided. As is common in computer programming, menus can be replaced with dialog boxes or wizards for guiding users through a selection process. The presented selection may be displayed sequentially (such as in nested menus) or simultaneously (such as in tool bars or pull-down menus). When menus are used, a user is not required to type thus the opportunity to make an incorrect selection or input is reduced. Similarly, when dialog boxes or wizards are used, it may be desirable to limit user's input to ticking selection boxes or buttons. Of course, a suitable combination of these presentation techniques may be used as well.

The logic S600 may be expanded to include more levels of selection or shortened to have less number of levels of selection depending on the application. It is also possible to have flexible levels of selection, i.e., at each level a user may optionally choose to make further selections or to terminate selection and start plotting. It can be appreciated that to increase the number of selection levels or to make selection recursive, the object filter and relationship filter can be alternatively and repeatedly presented and selected. The necessary modifications required to change the number of selection levels are obvious to a skilled person in the art and only require common knowledge and ordinary skills to implement.

For ease of operation or to limit errors, a user may be limited to choosing among the filters presented to the user which are automatically determined from the schema. However, for greater flexibility, it is possible to allow a user to modify certain filters, e.g., by imposing additional constraints. For example, a user may wish to graph memory usage of processes in a certain range, such as plotting only memory uses that are more than 100 Kb. In such a case, a user may modify one or more filters to select memory objects that have values more than 100 kb (e.g., object filter=“memory>100 k” ).

Although only a few examples are given above, those skilled in the art will readily appreciate that other modifications are possible.

The invention, rather, is intended to encompass all such modification within its scope, as defined by the claims.

What is claimed is:

1. A method of plotting numerical data, comprising:
selecting a root object;
presenting to a user for selection at least one filter, each of said at least one filter describing at least one of a type of objects and a type of reletionships between objects, each type of objects and each type of relationships between objects being defined by a schema;
receiving one or more user-selected filters;
based on said one or more user-selected filters, selecting a set of objects, each object of said set being related to said root object either directly, or through a chain of intermediate objects, where each chain of intermediate objects has the same length and all objects at a given level of each chain have a relationship with a parent object which is identical, each object of said set containing numerical data having a format suitable for a mathematical analysis;
arranging said mathematical analysis of said numerical data; and
plotting a result of said mathematical analysis of said numerical data on a graph.

2. The method of claim 1, further comprising:
obtaining said schema; and
populating said schema with said root object and objects related to said root object.

3. The method of claim 1, wherein said schema has object descriptors for describing objects and relationship descriptors for describing possible relationships between objects, said schema associating specific relationship descriptors between specific object descriptors, and at least one of said object descriptors describing a type of numerical data.

4. The method of claim 3 wherein said one or more user-selected filters comprise at least one relationship filter describing a given relationship for selecting objects having said given relationship with a parent object, and at least one object filter describing a given object type for selecting objects having said given object type.

5. The method of claim 4 wherein said given relationship is one of an attribute relationship ana a content relationship.

6. The method of claim 5 wherein at least one of said relationship descriptors describes a format relationship and said one or more user-selected filters comprise a format filter describing a given format for selecting objects containing numerical data having said given format.

7. The method of claim 1 wherein said root object is selected based on a user input.

8. The method of claim 1, further comprising selecting said mathematical analysis based on a user input.

9. The method of claim 1 wherein said presenting comprises displaying at least one menu having at least one selectable item.

10. The method of claim 9, wherein said at least one menu comprises at least one menu providing one or more relationships for selection, and at least one menu providing one or more types of objects for selection.

11. A manufacture comprising a computer readable medium containing computer executable code for plotting numerical data which when executed by a processor in a computer system, causes said computer system to:
select a root object;
presenting to a user for selection at least one filter, each of said at least one filter describing at least one of a type of objects and a type of relationships between objects, each type of objects and each type of relationships between objects being defined by a schema;
based on said one or more user-selected filters, select a set of objects, each object of said set being related to said root object either directly, or through a chain of intermediate objects, where each chain of intermediate objects has the same length and all objects at a given level of each chain have a relationship with a parent object which is identical, each object of said set containing numerical data having a format suitable for a mathematical analysis; receive one or more user-selected filters;
arrange said mathematical analysis of said numerical data; and
plot a result of said mathematical analysis of said numerical data on a graph.

12. The manufacture of claim 11, wherein said computer executable code when executed by said processor in said computer system, further causes said computer system to:
obtain said schema; and
populate said schema with said root object and objects related to said root object.

13. The manufacture of claim 11, wherein said schema has object descriptors for describing objects and relationship descriptors for describing possible relationships between objects, said schema associating specific relationship descriptors between specific object descriptors, and at least one of said object descriptors describing a type of numerical data.

14. The manufacture of claim 13 wherein said one or more user-selected filters comprise at least one relationship filter describing a given relationship for selecting objects having said given relationship with a parent object, and at least one object filter describing a given object type for selecting objects having said given object type.

15. The manufacture of claim 14 wherein said given relationship is one of an attribute relationship and a content relationship.

16. The manufacture of claim 15 wherein at least one of said relationship descriptors describes a format relationship and said one or more user-selected filters comprise a format filter describing a given format for selecting objects containing numerical data having said given format.

17. The manufacture of claim 11 wherein said root object is selected based on a user input.

18. The manufacture of claim 11, further comprising selecting said mathematical analysis based on a user input.

19. The manufacture of claim 11 wherein said presenting comprises displaying at least one menu having at least one selectable item.

20. The manufacture of claim 19 wherein said at least one menu comprises at least one menu providing one or more relationships for selection and at least one menu providing one or more types of objects for selection.

21. A computer system having a processor and a memory adapted for undertaking the method of claim 1.

22. A software tool for plotting numerical data, operable to:
select a root object;
present to a user for selection at least one filter, each of said at least one filter describing at least one of a type of objects and a type of relationships between objects, each type of objects and each type of relationships between objects being defined by a schema;
receive one or more user-selected filters;
based on said one or more user-selected filters, select a set of objects, each object of said set being related to said root object either directly, or through a chain of intermediate objects, where each chain of intermediate objects has the same length and all objects at a given level of each chain have a relationship with a next higher object in said each chain which is identical, each object of said set containing numerical data having a format suitable for a mathematical analysis; arrange said mathematical analysis of said numerical data; and plot a result of said mathematical analysis of said numerical data on a graph.
